(19) United States
(12) Patent Application Publication
(10) Pub. No.: US 2009/0287929 A1
(43) Pub. Date: Nov. 19, 2009

(54) METHOD AND APPARATUS FOR TWO-FACTOR KEY EXCHANGE PROTOCOL RESILIENT TO PASSWORD MISTYPING

(75) Inventors: Vladimir Kolesnikov, Union City, NJ (US); Charles Rackoff, Toronto (CA)

Correspondence Address: FAY SHARPE/LUCENT, 1228 Euclid Avenue, 5th Floor, The Halle Building, Cleveland, OH, 44115-1843, US

(73) Assignee: Lucent Technologies Inc.

(21) Appl. No.: 12/121,315

(22) Filed: May 15, 2008

(51) Int. Cl. H04L 9/14

(52) U.S. Cl. 713/171

(57) ABSTRACT

A system and method for two factor key exchange protocol resilient to password mistyping is disclosed. This authentication process is based on two factors including both electronically stored (long keys) and human supplied credentials (password or biometrics). The disclosed system and method ensures security in the presence of mistyping. The system includes receiving a message from a client signifying a request to establish a secure connection and sending a first random number to the client. The method continues with receiving a string and authorization code with parameters comprising the first random number and the string where the string includes an identifier, a short key and a second random number encrypted with a public key. The method continues with decrypting the string with a private key verifying the authentication code, verifying the short key and session key derivation by both server and client.

### BACKGROUND OF THE INVENTION

This disclosure relates to a method and apparatus for password security and authentication. More particularly, this disclosure relates to a method and apparatus for secure key exchange protocol that is resilient to password mistypings.

While this disclosure is particularly directed towards establishing a secure key exchange between a server and a client, even when the user password is misused, and will be thus described with specific reference thereto, it will be appreciated that this disclosure may have usefulness in other fields and applications. For example, this disclosure may be useful in a variety of key exchange services against adversaries that may want to gain access or create a denial of service situation.

By way of background, the problem of key exchange has deservedly received a great amount of attention. It has become increasingly important for key exchange to remain secure in order that adversaries do not gain access or cause denial of access situations. Password key exchange was first considered by Bellovin and Merritt (Steven M. Bellovin and Michael Merritt. Encrypted key exchange: Password-based protocols secure against dictionary attacks. In SP '92: Proceedings of the 1992 IEEE Symposium on Security and Privacy, page 72, Washington, D.C., USA, 1992. IEEE Computer Society). Formal definitions and protocols in this setting were given by Bellare, Pointcheval and Rogaway, Boyko, Mackenzie and Patel, (V. Boyko, P. MacKenzie, and S. Patel. Provably Secure Password-Authenticated Key Exchange Using Diffie-hellman. In B. Preneel, editor, Advances in Cryptology—EUROCRYPT 2000, volume 1807 of LNCS, pages 156-171. Springer, 2000), Goldreich and Lindell, Canetti et al. (Ran Canetti, Shai Halevi, Jonathan Katz, Yehuda Lindell, and Philip D. MacKenzie. Universally composable password-based key exchange. In Advances in Cryptology—EUROCRYPT 2005, volume 3494 of LNCS, pages 404-421. Springer. 2005) and others. The disclosures of these publications are hereby fully incorporated by reference.

The use of a combination of keys in authentication, where the client has a password and the public key of the server, was introduced by Gong et al.(Li Gong, T. Mark A. Lomas, Roger M. Needham, and Jerome H. Saltzer. Protecting poorly chosen secrets from guessing attacks. IEEE Journal on Selected Areas in Communications, II(5):648-656. 1993) and first formalized by Halevi and Krawczyk (Shai Halevi and Hugo Krawczyk. Public-key cryptography and password protocols. ACM Trans. Inf. Syst. Secur., 2(3):230-268, 1999). Kolesnikov and Rackoff (Key exchange using passwords and long keys. Theory of Cryptography, TCC 2006, volume 3876 of LNCS, pages 100-119, Springer, 2006) extended this setting by allowing the client to also share a long key with the server, and gave first definitions of key exchange in their (and thus in the Gong et al. and Halers & Krawczyk) setting. All of these works are also hereby fully incorporated by reference.

Despite the large key exchange research effort, the definitional issues of password mistyping are formally approached only in the UC definition of Canetti et al. In their password-only setting, mistyping is modeled by Environment Z providing players' inputs. Additional use of long key makes setting in this disclosure significantly different (and more subtle with respect to mistyping) from that of Canetti et al.

A growing body of work addresses the problem of the use of biometrics in cryptography. Boyen et al. (Xavier Boyen, Yevgeniy Dodis, Jonathan Katz, Rafail Ostrovsky, and Adam Smith. Secure remote authentication using biometric data. In Advances in Cryptology EUROCRYPT 2005, volume 3494 of LNCS, pages 147-163, 2005) and Boyen et al. (Xavier Boyen. Yevgeniy Dodis, Jonathan Katz, Rafail Ostrovsky, and Adam Smith. Secure remote authentication using biometric data (revised version). Available at http://www.cs.stanford.edu/˜xb/eurocrypt05b/.) consider its application to key exchange through the notion of Robust Fuzzy Extractor (RFE), and give generic constructions of biometric-based key exchange from robust fuzzy extractors. Prior art gives key exchange protocols that accept \close enough secrets, thus enabling security and privacy of biometric authentication. They do not aim to give a formal key exchange definition which handles biometric misreading/password mistyping. Moreover, prior art notions of RFE is insufficiently strong to guarantee security of their generic key exchange construction in many practical settings.

Even in optimized real-life systems, where scans are compared directly against each other, the FRR is usually 1-10%. Notably, fingerprints are reported to have FRR between 0.1% and 2% with FAR 1% and 2%. Even high-entropy iris scans have 0.2-1% FRR (NIST ). Less intrusive biometrics, such as face, have 10% FRR.

Therefore, there is a need in the industry for an apparatus and method that can activate practical two-factor authenticated key exchange protocol. It would be useful this system and method to allow servers to implement a key exchange with clients who use short passwords and long cryptographic keys. There is a need in the industry for this system and method to remain secure even when the client mistypes the password. There is also a need in the art for a system and method that remains secure through denial of access attacks.

The present disclosure contemplates a new and improved system and method which resolves the above referenced difficulties and others.

### SUMMARY OF THE INVENTION

A method and apparatus for establishing a secure key exchange between a server and a client is disclosed. Through this method short keys, e.g. passwords, may be mistyped and/or biometrics may be misread while this method will remain secure. Furthermore, this method provides protection over the denial of access attack. Therefore, even when the client mistypes the passwords, an adversary cannot easily lock the client out of the account. This in turn detours significant cost in terms of tech support calls.

In one aspect of the present disclosure, the method for establishing a secure key between a server and a client authenticated by a long secret key and user input includes receiving a message from the client signifying a request to establish a secure session and sending a first random number to the client. The method continues on with receiving a string that establishes a client and server relationship by binding the first random number and a public key encrypted message. The public key encrypted message includes parameters including a client identifier, a short key and a second random number. The string includes the public key encrypted message and a message authentication code authenticated by a long key of the public key encrypted message and the first random number. The method continues with decrypting the string verifying the short key and exchanging a secure key with the client configured to facilitate a secure session.

In accordance with another aspect of the present disclosure, the method includes outputting a session key that is configured to facilitate a secure session.

In accordance with another aspect of the present disclosure, the method includes that the short key is a numeric or alphanumeric password.

In accordance with another aspect of the present disclosure, the method includes that the short key is related to biometrics.

In accordance with another aspect of the present disclosure, the method includes that the long key is embedded in a banking card.

In accordance with another aspect of the present disclosure, the method includes that the long key is embedded in a mobile station.

In accordance with another aspect of the present disclosure, the method includes that the long key is embedded within a smart card.

In accordance with another aspect of the present disclosure, the method further includes that if decrypting the string fails, then outputting that there was a decryption failure.

In accordance with another aspect of the present disclosure, the method includes that if the password fails outputting that there was a password failure.

In accordance with another aspect of the present disclosure, the method includes that the identifier is a client's account number.

In accordance with another aspect of the present disclosure, the method includes that the encryption is non-malleable.

In accordance with yet another aspect of the present disclosure, a system for implementing a two factor authenticated key exchange comprises a public key configured to encrypt an identifier, a short key and a client generated random number where the public key is stored in a string. The system further includes a message authentication code authenticated by a long key where the parameters include a server generated random number and a string where the message authentication code is bound to the string and is received by a server. The system also includes a decryption module configured to decrypt the string, verify the message authentication code and signal confirmation that a key exchange will create a secure session with a client.

In accordance with another yet aspect of the present disclosure, the method for establishing a secure key exchange among a server and a client comprises generating a first random number, receiving a string and authentication code with parameters comprising the first random number and the string, where the string comprises an identifier, a short key and a second random number encrypted with a public key. The method further includes setting session identification equal to the string and the first random number, encrypting the string with a private key, verifying the authorization code, verifying the short key, and exchanging a secure key with the client.

In accordance with another aspect of the present disclosure, the method includes that the short key is facilitated by biometrics, including a fingerprinting and/or retina scanning.

In accordance with another aspect of the present disclosure, the clients' passwords need not be stored in the plaintext by the server's database, but can be stored in the hashed or encrypted form.

### DESCRIPTION OF THE DRAWINGS

The presently described embodiment and the construction, arrangement, and combination of the various parts of the device, and steps of the method, whereby the objects contemplated are attained as hereinafter more fully set forth, specifically pointed out in the claims, and illustrated in the accompanying drawings in which:

FIG. 1 illustrates a portion of the overall secured key exchange network.

FIG. 2 illustrates a flow chart according to one embodiment of the method according to the present disclosure.

FIG. 3 illustrates a flow chart according to another embodiment of the method according to the present disclosure.

### DETAILED DESCRIPTION

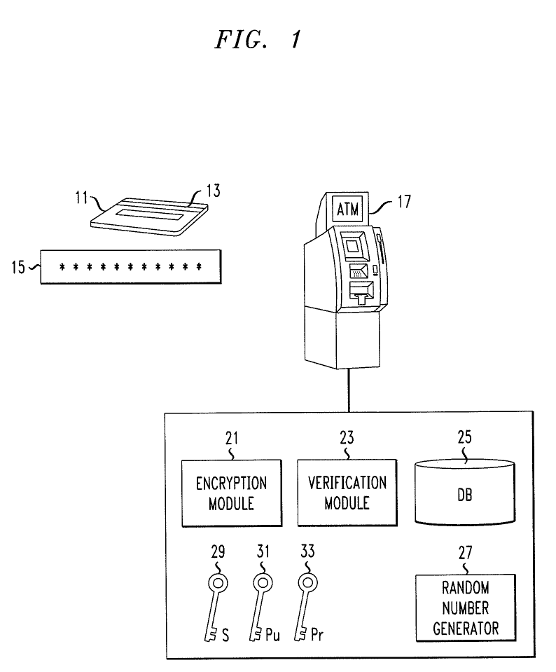

Referring now to the drawings wherein the showings are for purposes of illustrating the disclosed embodiments only and not for purposes of limiting the claimed subject matter, FIG. 1 provides an overall system into which the present disclosure may be implemented. The system includes a bank card 11, which has a long key 13 embedded therein, a short key 15, the client interface 17, as well as a server 19. The server 19 contains an encryption module 21, a verification module 23, a database 25, random number generator 27, a secure key 29, a public key 31 and a private key 33. FIG. 1 shows merely one embodiment in which the present disclosure may be implemented. This disclosure could include a variety of secure key exchange networks. This is but one example.

This system includes a bank card 11 which has a long key 13 embedded within. The bank card is but one of a variety of different mechanisms which could be used to store a long key 13. Other examples include a cellular phone, PDA or other user equipment. Other mechanisms may also include an RF chip, a smart card, a debit card or a credit card.

The client will also have a user input such as a short key 15. The short key may include a short numeric password and/or Personal Identification Number (PIN). The short key 15 may also include biometrics. Biometrics includes a retina scan, fingerprinting, voice recognition, hand degometry, iris scan, face recognition, etc.

The system also includes a client interface 17. In FIG. 1, the client interface resembles an automatic teller machine. However, the client interface may include a website, a cellular communications network or any other means generally used to communicate with the server 19.

Server 19 includes encryption module 21, verification module 23, database 25, and a random number generator 27. The server 19 also includes within a secure key 29 which is used in order to establish a secure connection with the client. The server 19 also includes a public key 31. A public key 31 uses cryptography in order to encrypt a message from the public. The server also has a private key 33. Only the server 19 can access the private key 33 which is used to decrypt the message encrypted by the public key 31.

Still referring to FIG. 1, generally a client will use the bank card 11 embedded with the long key 13 and a short key 15 in order to access the account. The account may also be accessed through some type of client interface 17 which communicates with the server 19. The method may be implemented through the method provided in the table (Table 1) below.

TABLE 1

| S^{C} | | C^{S} |
|---|---|---|
| choose r ε_{R} {0, 1}ⁿ | | choose k ε_{R} {0, 1}ⁿ, |
| | r → | |
| | | set α = Enc_{pkS}(N_{C},pwd, k) |
| | ← α, MACₗ(r, α) | |

| | |
|---|---|
| set sid = (r, α), out = OK; | set sid = (r, α) |
| decrypt α | |

if fail, set N_{C} = ⊥, k ε_{R} {0, 1}ⁿ:

verify MACₗ(r, α) and N_{C}

if fail, set out = ⊥
else verify pwd

if fail, set out = P⊥;

| set K = F_{F}_{ₖ}₍ᵣ₎(0), K′ = F_{F}_{ₖ}₍ᵣ₎(1) | | set K = F_{F}_{ₖ}₍ᵣ₎(0), K′ = F_{F}_{ₖ}₍ᵣ₎(1) |
|---|---|---|
| | F_{K′}(out) → | |

decode out ε {P⊥, ⊥, OK}

if fail, output (sid,⊥)

| | | if out = P⊥, output (sid,P⊥^{C}) |
|---|---|---|
| If out = OK, output (sid, K) | | if out = ⊥, output (sid,⊥) |
| | else output (sid, out) | if out = OK, output (sid, K) |

Through this method an adversary would be unable to gain information about a client's account (e.g. long key or short key) based on client's mistyping of the password 15.

It should be noted that short key 15 may also be applicable in natural ways to biometric-based authentication. For example, fuzzy extractors can be naturally used in two factor authentication settings. The storage card 11 may also contain public data of a client's biometric information. The randomness extracted from the client's biometrics play a role in the password 15. To authenticate, the client first reconstructs the password 15 using an extractor's recovery procedure, which is known in the art and depends greatly on the biometrics used. However, when the biometric is misread, that can cause a variety of outputs in receiving, and thus effect mistypings in a secure key exchange method. However, properties of our protocol and (and the fuzzy extractor) guarantee security of this construction, even if an adversary has captured the card 11 with the long key 13.

As shown in Table 1, the method begins with choosing a random number r. The server 19 generates this random number through the random number generator 27. At the same time, the client generates a random number k. This is generally a function of the client interface 17. For security purposes, both of these random numbers should be large, e.g. 128 bits long.

Random number r is then sent to the client so that the client may set a string α which includes parameters Nc, the password 15 and the random number k. Nc may be equal to the client's account number which the client knows (e.g. by storing it on the card), and the server may retrieve it by a look up in database 25. This string α is encrypted using the public key 31 which client knows (e.g. by storing it on the card). The client subsequently forwards the string α and a message authentication code authenticated by the long key 13 with parameters including the first random number r and α. The method continues with setting a session identification equal to first random numbers and string α, also (temporarily) setting the output equal to OK. The client in turn would do the same, setting the session identification equal to the first random number r and α.

The server 19 will then decrypt α using the private key 33. If there is a failure at this point, the Nc would be set equal to failure and session terminated. New session (and a new key exchange procedure) must be initiated if the client wishes to try to connect to the server.

The method continues with verifying the MAC and the Nc. If this fails the output would be equal to failure, however, if this does not fail then the password 13 may be verified. If the password 13 is misread or entered incorrectly, the output would be equal to password failure. The secure key 29 is then computed by the server if the output is equal to OK. If desired, the client may be notified whether the server accepted the session, and, if applicable, what error message the server output (failure or password failure).

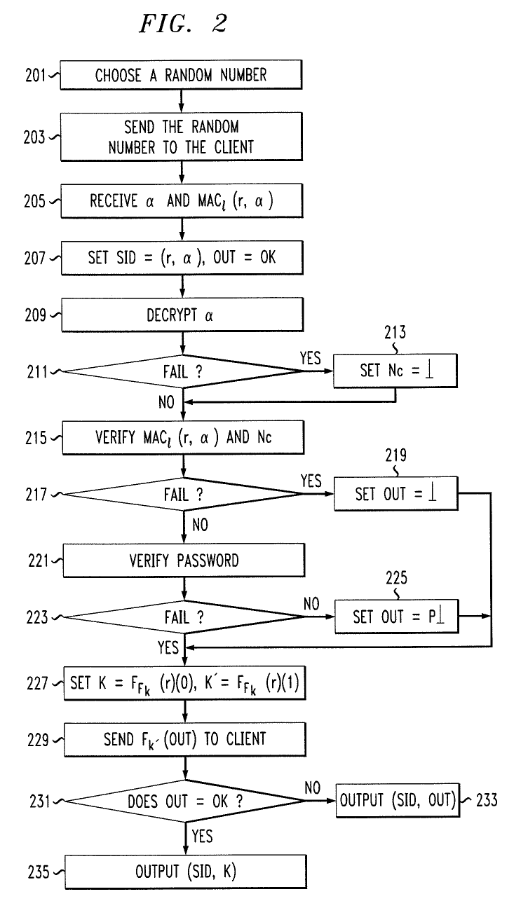

Now referring to FIG. 2, a method of establishing a secure key exchange is shown. The method begins with server selecting a random number at step 201. The random number generator 27, FIG. 1, may be used in order to implement this step. The method continues with sending the random number generated to the client at step 203.

The method continues with server receiving an α and a MAC authenticated by the long key with parameters with the first random number and a. As shown in Table 1, α will generally include the Nc (client's account number), the password (short key) and a random number k encrypted through use of the public key 31.

The method continues (at step 207) with setting the session ID equal to the first random number and a, setting the output equal to OK. It should be noted if the output remains OK throughout the message, then the secure key will be exchanged and a session will be established. However, only if the verification and decryptions succeed throughout this method will the output remain OK. Therefore, the method continues with decrypting a (at step 209). The encryption module 21 will generally be used in order to decrypt a using the private key 33. This private key 33 may only be accessed by the server 19 so that the client is assured that only the intended party can decrypt the message.

If decryption fails then the Nc is set equal to the failure, signifying that a failure has occurred at the decryption stage of the method (at step 213). However, if decryption was successful (at step 211) the method continues with verifying the MAC (at step 215). As noted above, at step 213, if the decryption failed, the Nc will be set to failure. There can be no verification of the Nc (at step 215) if it was set to failure. Therefore, if the MAC and/or Nc fail (at step 217) then the output will be set to failure (at step 219). However, if verification is successful, the method continues (at step 221) with verifying the password.

The method continues with a determination if the password can be verified (at step 223). There are many reasons why a password may not be verified, especially if the password is facilitated through biometrics. However, a user may have a password that must be implemented and the user may mistype. In either scenario, if there is a failure to verify the password, the output will be set at password failure (at step 225). If the password verification is successful, the method continues with setting the session key K and notification key K′ (at step 227).

If it is desired to notify the client of the server's acceptance status, the method continues with sending the F_{K}′ (out) to the client (at step 229). At this point, the client will be updated on the status of the server 19 verification. If at any point the client could not establish a connection with the server, the output will not be equal to OK. For example, if the decryption of a failed, the Nc would be set equal to failure and the output would be set equal to failure. In another form, the password cannot be verified and the output would be equal to Password failure. (If application does not require client of being informed of the server's acceptance status, sending F_{K}′ (out) and the corresponding verification may be omitted, and both server and client may proceed to use their derived keys.)

Therefore (at step 231) a determination is made as to whether the output is still equal to OK. If the output is still OK, the server may proceed with using the derived key. However, if at some point the output was changed from OK to a failure, the output signifying which failure disrupted the process will be output at step 233 (and the client may be securely notified as described above if desired).

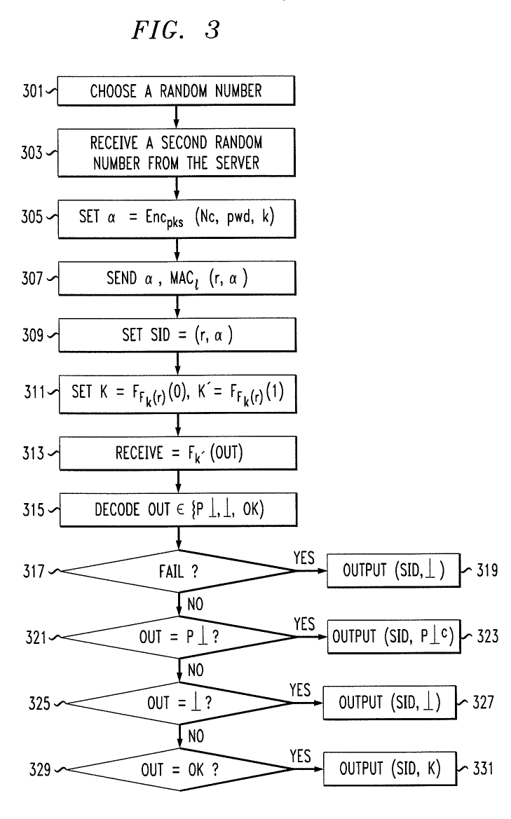

Now referring to FIG. 3, the method of establishing a secure key exchange from a client's perspective is shown. The method begins with the client choosing a random number k, at step 301. A random number generator may be used in order to implement this step. The method continues with receiving a second random number r, from the server (at step 303). Generally, this random number would have been sent at step 203, FIG. 2.

The method continues with setting α equal to Nc password and the random number k. This α would be encrypted using the public key 31. Nc may be equal to the client's account number and the password may be equal to a short key, such as an alpha numeric password, biometrics, etc.

The method continues (at step 307) with sending the α along with the method authentication code embedded within the long key with parameters including the second random number r and α. The method continues (at step 309) with setting the session ID as dependent upon r and α.

The method continues (at step 311) with setting K equal to the session key. This is implemented through a pseudo random function F with parameters including Fₖ and r. Furthermore K′ will be set equal to the same pseudo random function with a different starting point, e.g., 1. This will create two different keys, K and K′. Here K would be used as a session key, and K′ would be used for decryption of server's notification of its acceptance status. In applications where client needn't know server's acceptance status, the generation and use of K′ may be omitted both by client and server.

The method continues (at step 313) with receiving server's acceptance status encrypted with K′. The method continues (at step 315) with decrypting its status out. If decryption fails (at step 317) then client's output would include the session ID and a failure. If the decoding did not fail, but out was set to denote Password failure, then the output would equal the session ID and a signal signifying that the password failed (at step 323). If the output failed (at step 325), then the session would output the session ID and a failure (at step 327).

If the output is equal to OK (at step 329), then the output would include the session ID and the session key (at step 331). In this form, as was the case in FIG. 2, the server and the client would both have derived a session key, enabling them to communicate securely using said session key.

The above described embodiments as shown in FIG. 2 and FIG. 3 present but one embodiment of the described disclosure. Implementation of the various network elements and steps that they perform depend on how the system is used. These functions may be performed by some or all of the various network elements in conjunction or separate from one another. Furthermore, variations of the network elements and steps of the method may exist. Descriptions of these embodiments are not meant to limit the claims but instead show how some embodiments of the method may be used.

The above description merely provides a disclosure of particular embodiments of the invention and is not intended for the purposes of limiting the same thereto. As such, the invention is not limited to only the above-described embodiments. Rather, it is recognized that one skilled in the art could conceive alternative embodiments that fall within the scope of the invention.

We claim:

1. A method of establishing a secure key between a server and a client authenticated by a long secret key and user input, where the credentials of all parties and the session key remain secure when the user input is misused comprising:
receiving a message from a client signifying a request to establish a secure session;
sending a first random number to said client;
receiving a string that establishes a client and server relationship by binding said first random number and a public key encrypted message where said public key encrypted message includes parameters including an identifier, a short key and second random number, where said string includes said public key encrypted message and a message authentication code authenticated by a long key of said public key encrypted message and said first random number;
decrypting said string;
verifying said short key; and
establishing said secure key with said client configured to facilitate said secure session.

2. The method according to claim 1, further composing outputting a session key that is configured to facilitate secure session.

3. The method according to claim 1 wherein said short key is a numeric or alphanumeric password.

4. The method according to claim 1 wherein said short key is related to biometrics.

5. The method according to claim 1 wherein said long key is embedded in a card.

6. The method according to claim 1 wherein said long key is embedded in a mobile station.

7. The method according to claim 1 wherein said long key is embedded within a smart card.

8. The method according to claim 1, further comprising if decrypting said string fails outputing that there was a decryption failure.

9. The method according to claim 1, further comprising if password fails outputing that there was a password failure.

10. The method according to claim 1 wherein said identifier is a client's account number.

11. The method according to claim 1 wherein said encryption is non malleable.

12. The method according to claim 1 further comprising implementing denial of access protection by outputting separate error messages for errors associated with said short key and other errors.

13. A system for implementing a two factor authenticated key exchange comprising:
a public key configured to encrypt an identifier, a short key and a client generated random number, where said public key is stored in a string; a message authentication code authenticated by a long key with parameters including a server generated random number and said string, where said message authentication code is bounded to said string and received by a server; and
a decryption module configured to decrypt said string, verify said message authentication code and signal confirmation that a key exchange will create a secure session with a client.

14. The system according to claim 13 wherein said short key is a client password.

15. The system according to claim 13 wherein said short key is entered through biometrics.

16. The system according to claim 13 wherein said long key is stored on a mobile station.

17. A method of establishing a secure key exchange among a server and a client comprising:
generating a first random number;
receiving a string and authorization code with parameters comprising said first random number and said string, where said string comprises an identifier, a short key and a second random number encrypted with a public key;
setting session identification equal to said string and said first random number;
decrypting said string with a private key;
verifying said authorization code;
verifying said short key; and
establishing a secure key with said client.

18. The method according to claim 17 wherein said short key is facilitated via biometrics.

19. The method according to claim 18 wherein biometrics includes fingerprinting.

20. The method according to claim 18 wherein biometrics includes retina scanning.
